(19) United States
(12) Patent Application Publication
(10) Pub. No.: US 2022/0395128 A1
(43) Pub. Date: Dec. 15, 2022

(54) PORTABLE COLD BREWER WITH DRINKWARE

(71) Applicant: Toddy, LLC, Loveland, CO (US)

(72) Inventors: Julia Leach, Denver, CO (US); Clint Kolda, Loveland, CO (US); ANDREW LEACH, Denver, CO (US)

(21) Appl. No.: 17/806,459

(22) Filed: Jun. 10, 2022

Related U.S. Application Data
(60) Provisional application No. 63/209,387, filed on Jun. 10, 2021.

(51) Int. Cl. A47J 31/00; A47J 31/06; A23F 5/26; A23F 3/18; B65D 51/24; B65D 43/02

(52) U.S. Cl. CPC A47J 31/005; A47J 31/0615; A47J 31/0636; A23F 5/26; A23F 3/18; B65D 51/242; B65D 43/0231

(57) ABSTRACT

Disclosed is a portable cold brewer with drinkware for brewing a brewed effluent from a filter bag containing an organic material. The portable cold brewer with drinkware comprises a brewing section, a mid-section, and a lid. The brewing section includes a housing having a brewing section top and a brewing cavity within the housing. The brewing cavity includes an organic material measure marking and a brew line marking. The organic material measure marking is configured to measure an amount of organic material that will fill the filter bag, the brewing cavity is configured to receive the filter bag containing the organic material that was measured by the organic material measure marking, and the brew line marking is configured to measure an amount of water to fill the brewing cavity when the filter bag is inserted into the brewing cavity. The mid-section has a dilution section and a dilution line marking, where the mid-section is configured to cover the brewing section top, and the lid is configured to cover the dilution section.

### CROSS-REFERENCE TO RELATED APPLICATIONS

The application claims priority under 35 U.S.C. § 119(e) to U.S. Provisional Patent Application No. 63/209,387, titled “PORTABLE COLD BREWER AND DRINKWARE,” filed on Jun. 10, 2021, which is herein incorporated by reference in its entirety.

### BACKGROUND

### 1. Field

The present disclosure is related to systems and methods for brewing coffee or tea, and more particularly, system and methods for cold brewing coffee or tea.

### 2. Related Art

Cold brewing of coffee, tea and other water-soluble organic materials has been a popular procedure. Good tasting drinks are created in this manner.

### SUMMARY

A portable cold brewer with drinkware for brewing a brewed effluent from a filter bag containing an organic material is disclosed. The portable cold brewer with drinkware comprises a brewing section, a mid-section, and a lid. The brewing section includes a housing, where the housing includes a brewing section top and a brewing cavity within the housing. The brewing cavity includes an organic material measure marking and a brew line marking. The organic material measure marking is configured to measure an amount of organic material that will fill the filter bag, the brewing cavity is configured to receive the filter bag containing the organic material that was measured by the organic material measure marking, and the brew line marking is configured to measure an amount of water to fill the brewing cavity when the filter bag is inserted into the brewing cavity. The mid-section has a dilution section and a dilution line marking, where the mid-section is configured to cover the brewing section top, and the lid is configured to cover the dilution section. The mid-section has an outside portion and an inside portion defining a dilution cavity within the dilution section that is configured to receive the filter bag once the filter bag is removed from the brewing cavity and the mid-section is overturned and placed on the brewing section top. The mid-section is configured to drain the brewed effluent from the filter bag when the filter bag is in a resting position within the dilution cavity and the dilution line marking is configured to measure an additional amount of water to fill the mid-section when the brewed effluent has drained from the filter bag.

As disclosed is a method for cold brewing the brewed effluent from the filter bag containing the organic material in the portable cold brewer with drinkware. The method includes filling the brewing section cavity within the brewing section with the organic material until the organic material reaches an organic material measuring marking, filling the filter bag with the organic material from the brewing section cavity, placing the filter bag within the brewing section cavity, and adding water to the brewing section cavity until a water level of the water reaches a brew line marking within the brewing cavity. The method further includes placing the mid-section on the top of the brewing section, placing the lid on the top of the outside portion of the mid-section, and cold brewing the brewed effluent from the filter bag containing the organic material within the brewing section. The method then includes removing the lid from the top of the outside portion of the mid-section, removing the mid-section, removing the filter bag from the brewing section cavity, overturning the mid-section such that the outside portion rests on the top of the brewing cavity, placing the filter bag within the dilution cavity of the mid-section, and draining the brewed effluent from the filter bag into the brewing section cavity of the brewing section through the dilution section.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a front view of an example of an implementation of portable cold brewer with drinkware (PCBD) in accordance with the present disclosure.

FIG. 2 is an exploded view of the PCBD, shown in FIG. 1, in accordance with the present disclosure.

FIG. 3 is an isometric view of the mid-section of PCBD, shown in FIGS. 1 and 2, in accordance with the present disclosure.

FIG. 4 is a cut-away front view of the PCBD, shown in FIG. 1, in accordance with the present disclosure.

FIG. 5 is a cut-away front view of the brewing section of the PCBD, shown in FIG. 4, in accordance with the present disclosure.

FIG. 6 is a cut-way front view of the combination of the brewing section and mid-section of the PCBD, shown in FIG. 4, in accordance with the present disclosure.

FIG. 7 is an isometric view of the PCBD, shown in FIG. 1, draining a filter bag of organic material in accordance with the present disclosure.

FIG. 8 is a flowchart of a method performed by the PCBD shown in FIGS. 1 through 3 in accordance with the present disclosure.

### DETAILED DESCRIPTION

Disclosed is a portable cold brewer (PCBD) with drinkware for brewing a brewed effluent from a filter bag containing an organic material. The PCBD comprises a brewing section, a mid-section, and a lid. The brewing section includes a housing, where the housing includes a brewing section top and a brewing cavity within the housing. The brewing cavity includes an organic material measure marking and a brew line marking. The organic material measure marking is configured to measure an amount of organic material that will fill the filter bag, the brewing cavity is configured to receive the filter bag containing the organic material that was measured by the organic material measure marking, and the brew line marking is configured to measure an amount of water to fill the brewing cavity when the filter bag is inserted into the brewing cavity. The mid-section has a dilution section and a dilution line marking, where the mid-section is configured to cover the brewing section top, and the lid is configured to cover the dilution section. The mid-section has an outside portion and an inside portion defining a dilution cavity within the dilution section that is configured to receive the filter bag once the filter bag is removed from the brewing cavity and the mid-section is overturned and placed on the brewing section top. The mid-section is configured to drain the brewed effluent from the filter bag when the filter bag is in a resting position within the dilution cavity and the dilution line marking is configured to measure an additional amount of water to fill the mid-section when the brewed effluent has drained from the filter bag.

As disclosed is a method for cold brewing the brewed effluent from the filter bag containing the organic material in the PCBD. The method includes filling the brewing section cavity within the brewing section with the organic material until the organic material reaches an organic material measuring marking, filling the filter bag with the organic material from the brewing section cavity, placing the filter bag within the brewing section cavity, and adding water to the brewing section cavity until a water level of the water reaches a brew line marking within the brewing cavity. The method further includes placing the mid-section on the top of the brewing section, placing the lid on the top of the outside portion of the mid-section, and cold brewing the brewed effluent from the filter bag containing the organic material within the brewing section. The method then includes removing the lid from the top of the outside portion of the mid-section, removing the mid-section, removing the filter bag from the brewing section cavity, overturning the mid-section such that the outside portion rests on the top of the brewing cavity, placing the filter bag within the dilution cavity of the mid-section, and draining the brewed effluent from the filter bag into the brewing section cavity of the brewing section through the dilution section.

In this example, the PCBD is a portable eco-friendly product that can be used as both a brewing vessel and insulated drinkware. The PCBD may be used to cold brew organic material such as, for example, coffee or tea. The organic material may be placed in a filter bag and/or sachet. As an alternative, pre-filled sachet of organic material may be utilized instead of the filter bag.

In general, the PCBD may be designed and engineered for optimal thermal performance utilizing material such as, for example, double-wall vacuum insulated brew chamber, double wall vacuum insulated dilution section, and a foam insulated lid. With these types of materials (or other equivalent materials) the PCBD may be designed to keep an effluent liquid of cold brew cold all day. As an example, the external portions of the PCBD may be constructed of plastic, hard rubber, glass, ceramic, or metal such as, for example, high quality, food safe 18/8 stainless steel. All of the seals and a filter tie may be constructed from durable and long-lasting food grade silicone. The PCBD is dishwasher safe; easily cleanable (having full-width threads to allow the PCBD to separate into the brewing section, mid-section, and lid); eco-friendly since it eliminates single use cups and uses compostable filter media and a reusable silicone filter tie; easy to use with no measuring required (i.e., utilizing brew and fill lines); easily carriable with a lid that has dual loops for securing with carabiner, etc.

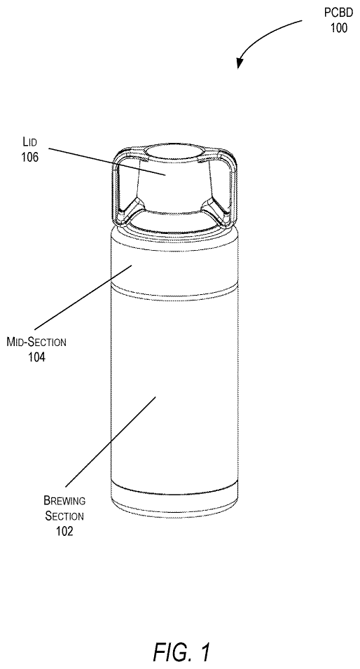

Turning to FIG. 1, a front view of an example of an implementation of the PCBD 100 is shown in accordance with the present disclosure. The PCBD 100 includes a brewing section 102, mid-section 104, and lid 106.

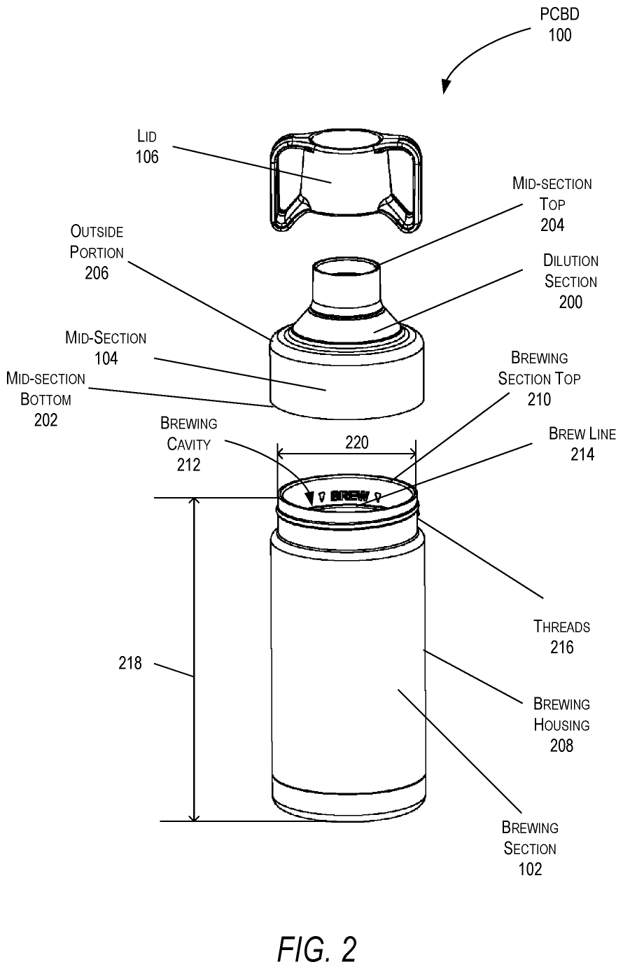

In FIG. 2, an exploded view of the PCBD 100 is shown in accordance with the present disclosure. In this view, the mid-section 104 includes a dilution section 200, a mid-section bottom 202, mid-section top 204, outside portion 206, and an inside portion (not shown in this view). The brewing section 102 includes a housing 208 having a brewing top 210 defining an opening into the top of the brewing section 102, a brewing cavity 212 within the brewing section 102, a brew line 214 within the brewing cavity 212, and a first set of threads 216 on the outside of the housing 208 near the brewing section top 210. In this example, the brewing housing 208 may be a cylindrical housing constructed of plastic, hard rubber, glass, ceramic, or metal. As an example, the housing 208 may have a height 218 of approximately 178 millimeters and the brewing section top 210 may have a diameter 220 of approximately 85 millimeters.

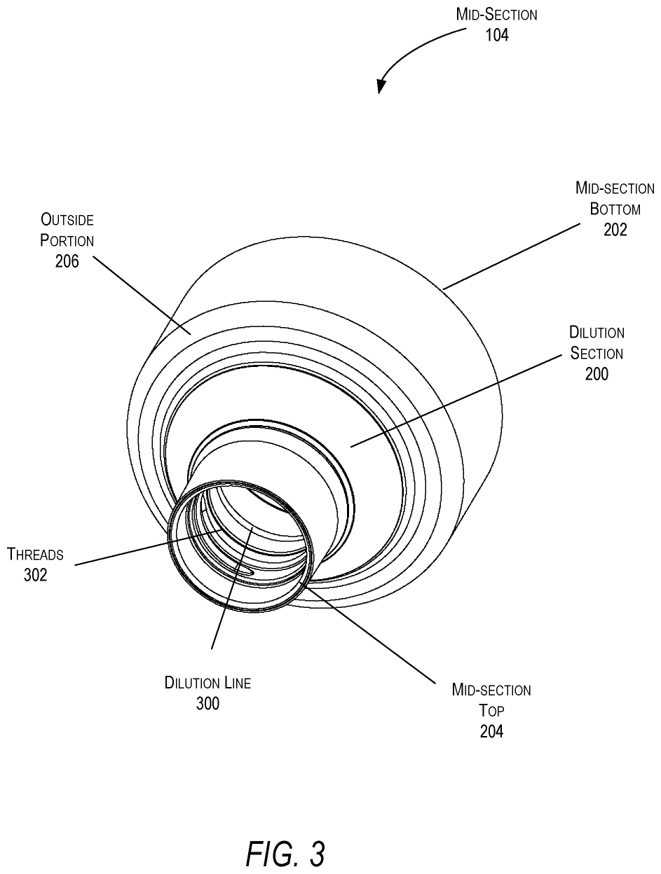

In FIG. 3, an isometric view of the mid-section 104 of the PCBD 100 is shown in accordance with the present disclosure. The dilution section 200 is shown to include a fill line 300 and a set of threads 302 at the mid-section top 204. In this example, the dilution section 200 includes an inside portion defining a dilution cavity within the dilution section 200. The inside portion may include a concave surface that acts as a funnel.

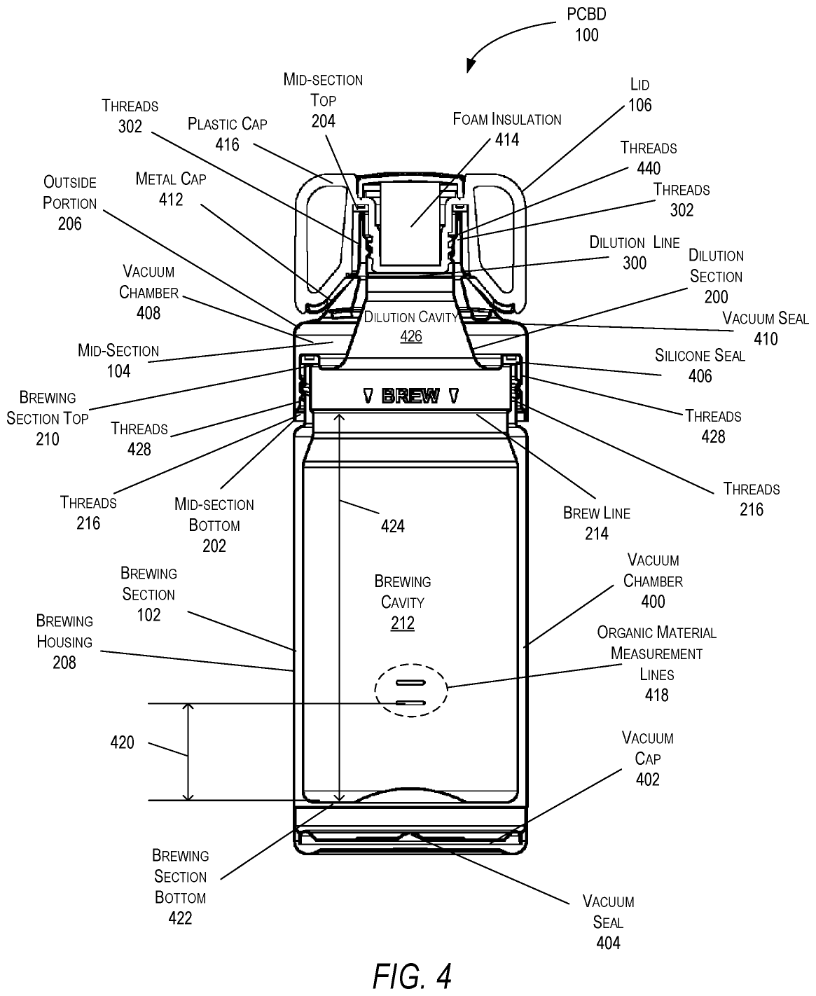

FIG. 4 is a cut-away front view of the PCBD 100 in accordance with the present disclosure. In this example, the brewing section 102 may include the brew line 214, a vacuum chamber 400, vacuum cap 402, and vacuum seal 404. The mid-section 104 may include a silicone seal 406, vacuum chamber 408, a vacuum seal 410, silicone cap 412, and the fill line 300. The Lid 106 may include a foam insulation 414 and a plastic cap 416.

In this example, the brewing section 102 comprises the housing 208 that includes the brewing section top 210 and brewing cavity 212 within the housing 208. In this example, the brewing cavity 212 includes one or more organic material measurement markings 418 and the brew line 214 marking. The one or more organic material measurement markings 418 are marking to indicate to a user the amount of organic material that should be poured into the brewing cavity 212 to properly brew the organic material. This organic material will then be pound into the filter bag to fill the filter bag by proper amount need to brew the organic material. In this example, the organic material may be coffee or tea and, as an example, a first organic material measure marking, of the one or more organic material measurement markings 418, may be for use with tea while the other organic material measure marking may be for use with coffee. Alternatively, the first organic material measure marking, of the one or more organic material measurement markings 418, may be light roast coffee or tea and the other organic material measure marking may be for used for dark roast coffee or tea. As an example, the first organic material measure marking may be located at a height 420 of 36 millimeters from a brewing section bottom 422 of the brewing section 102. The brew line 214 is configured to measure an amount of water to pour into the brewing cavity 212 when the filter bag is inserted into the brewing cavity 212. As an example, the brew line 214 may be located at a height 424 of 142 millimeters from a brewing section bottom 422 of the brewing section 102.

Moreover, in this example, the mid-section 104 includes the outside portion 206 and an inside portion defining a dilution cavity 426 within the dilution section, wherein the dilution section is configured to receive the filter bag once the filter bag is removed from the brewing cavity 212 and the mid-section 104 is overturned (i.e., flipped over) and placed on the brewing section top 210. The mid-section 104 includes the dilution line 300 and the mid-section 104 also includes a set of threads 428 on the inside portion of the mid-section 104. In this example, the dilution line 300 marking is configured to measure an additional amount of water to fill the mid-section 104 when the brewed effluent has drained from the filter bag.

In this example, the brewing section top 210 of the housing 208 includes the first set of threads 216 and the mid-section bottom includes the second set of threads 428 within the inside portion of the mid-section 104 configured to physically interface with the first set of threads 216 of the brewing section top 210. The inside portion of the mid-section 104 is configured to be removably attached to the brewing section top 210 by attaching the second set of threads 428 to the first set of threads 216 to form a watertight seal between the brewing section 102 and the mid-section 104.

Additionally, the mid-section 104 includes the mid-section top 204 above the dilution cavity 426 and the third set of threads 302 within the inside portion of the mid-section 104 at the mid-section top 204. The lid 106 includes a fourth set of threads 440 that are configured to physically interface with the third set of threads 302 of the mid-section 104. In this example, the lid is configured to be removably attached to the mid-section top 204 by attaching the fourth set of threads 440 to the third set of threads 302 to form a watertight seal between the mid-section top 204 and the lid 106. In this example, the lid 106 may include a lid handle that may be the plastic cap 416.

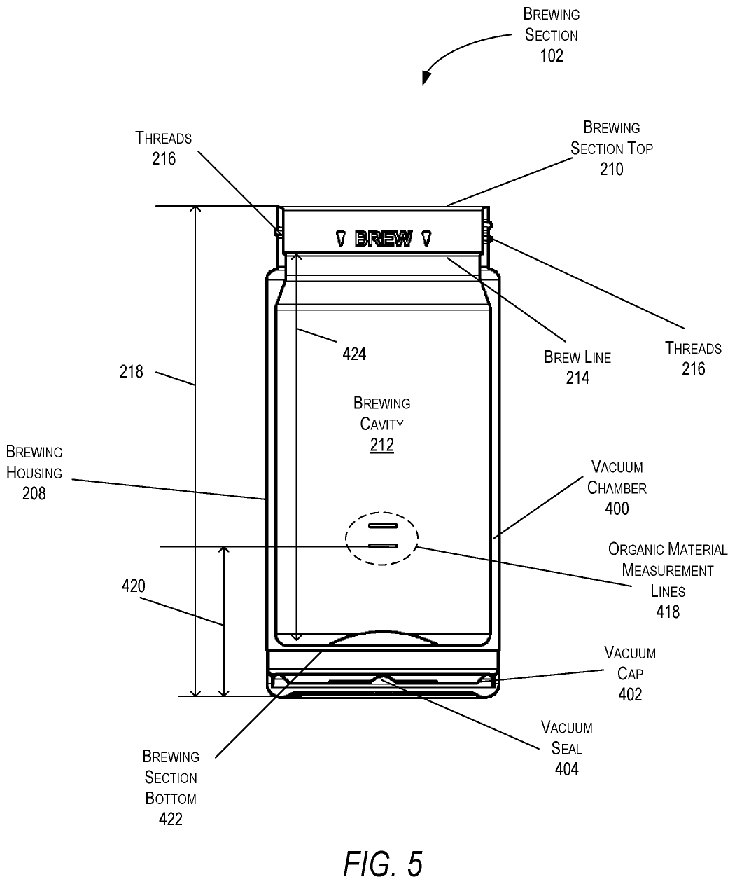

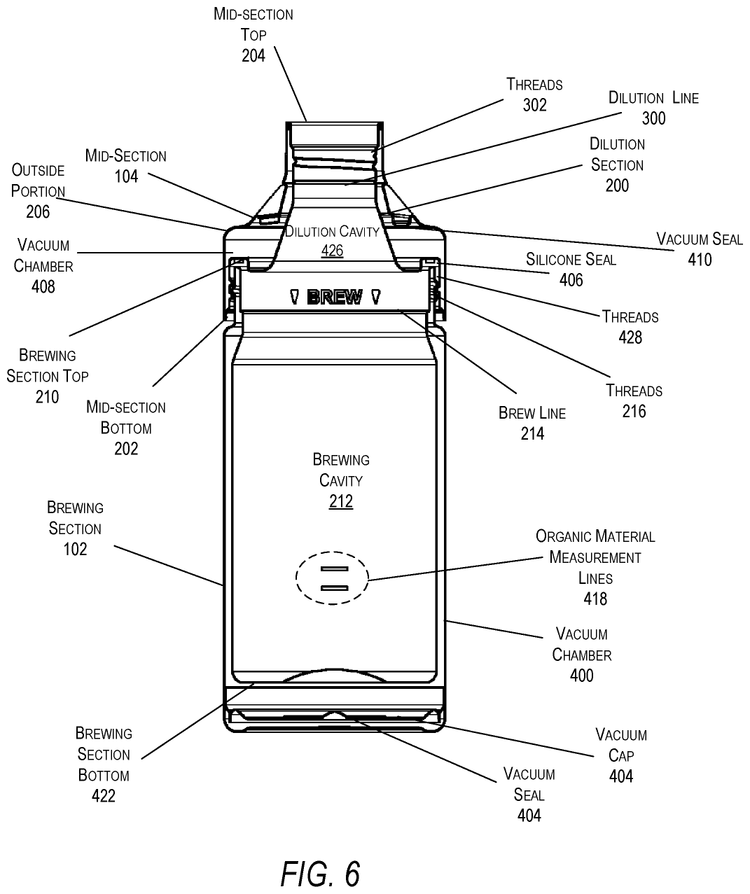

FIG. 5 is a cut-away front view of the brewing section 102 in accordance with the present disclosure. In FIG. 6, a cut-way front view of the combination of the brewing section 102 and mid-section 104 is shown in accordance with the present disclosure. In these views, the one or more organic material measurement markings 418 and brew line 214 are shown within the inside wall of the cavity within the brewing section 102. Additionally, the dilution/fill line 300 is shown along the inside wall of the dilution section 200 of the mid-section 104.

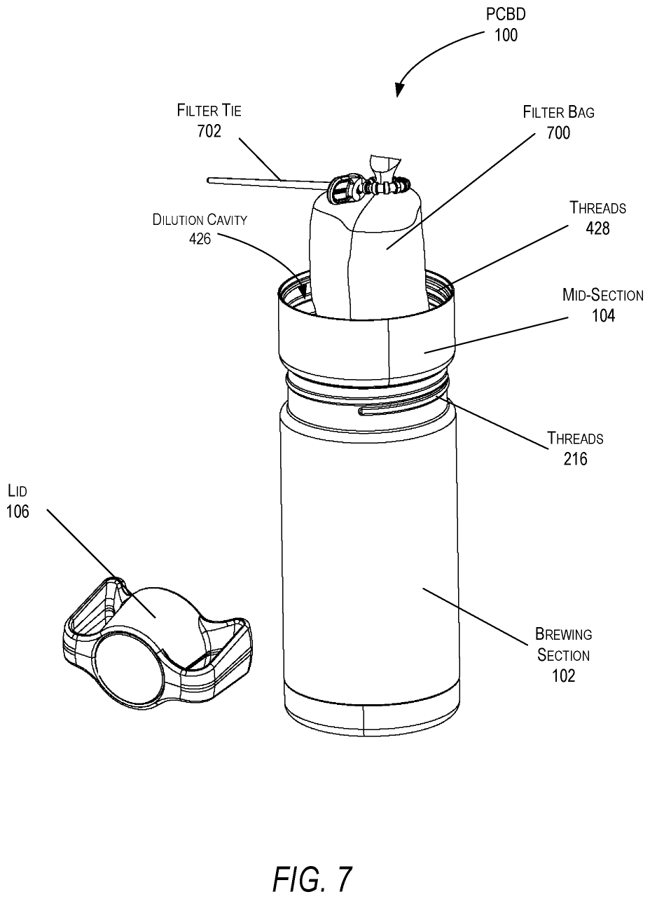

FIG. 7 is an isometric view of the PCBD 100 draining a filter bag 700 of organic material in accordance with the present disclosure. The method for brewing the filter bag 700 will be described below. In general, the method is process that includes the following steps.

In the first step, if organic material is not pre-packaged in a cold brew sachet (i.e., a pre-packaged filter bag 700), the organic material may be measured by utilizing the one or more organic material measurement markings 418 within the walls of inner cavity of the brewing section 102. There may be multiple lines for the one or more organic material measurement markings 418 because there is generally a volumetric difference between the equal weights of dark roast coffee, light roast coffee, or tea. As such, the organic material may be poured into the brewing section 102 and compared against the different lines of the one or more organic material measurement markings 418 to determine the proper amount of organic material to use. Once measured, the organic material may be poured out of the brewing section 102 into the filter bag 700 that may have its top secured by a filter tie 702. The filter bag 700 is then placed into the cavity of the brewing section 102 and cavity is filled with water until the water level reaches the brewing line 214. The mid-section 104 and lid 106 are then placed on and the organic material is allowed to brew for a certain period of time, for example, 12 to 24 hours.

In the second step, the mid-section 104 is removed and the filter bag 700 is extracted from the cavity of the brewing section 102. The mid-section 104 is then inverted and placed on the top of the brewing section 102 and filter bag 700 is placed on the inside of the inverted mid-section 104 (i.e., on the dilution section 200) and allowed to drain out of the filter bag 700 into the effluent liquid in the cavity of the brewing section 102.

In this third step, the filter bag 700 is removed and ice, flavorings, dairy, or diary alternatives may be added via the dilution section 200. Once these additions are added, the mid-section 104 is removed, inverted, and re-installed on the top of the brewing section 102. Water may then be added to the PCBD 100 to the final dilution line (i.e., dilution/fill line 300). The lid 106 is then placed on the top of the mid-section 104 and the process is complete.

In this example, it is appreciated by those of ordinary skill in the art that instead of utilizing a filter bag with the organic material, pre-filled and sealed coffee or tea sachets may also be utilized.

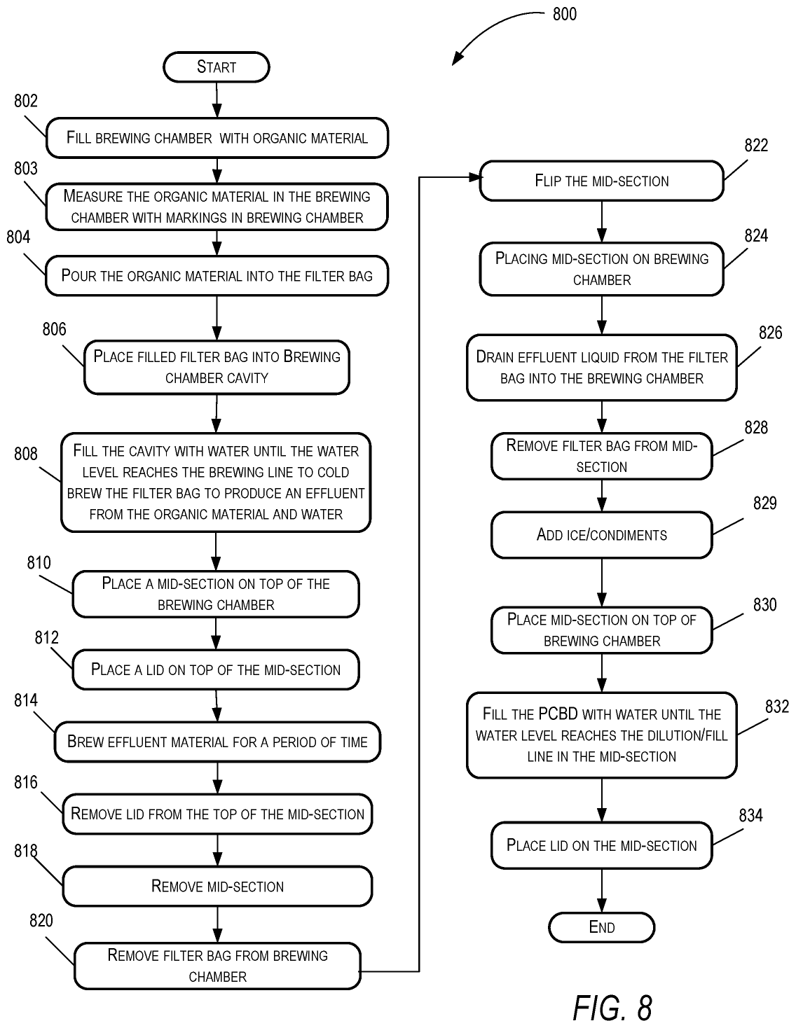

FIG. 8 is a flowchart of a method performed by the PCBD 100 in accordance with the present disclosure. The method 800 starts filling 802 the brewing section cavity with the organic material until the organic material reaches the organic material measuring marking; measuring 803 the amount of organic material with the organic material measuring marking; pouring 804 the filter bag with the organic material from the brewing section cavity; pouring 804 out the organic material into the filter bag 700; placing 806 the filter bag within the cavity of the brewing section 102; filling 808 the cavity of the brewing section 102 with water until the water level reaches the brew line 214; placing 810 a mid-section on top of the brewing section, wherein the mid-section 104 includes a dilution section 200, an outside portion, and an inside portion having a recess; placing 812 a lid on top of the outside portion of the mid-section 104; cold brewing 814 a brewed effluent from the filter bag 700 containing the organic material; removing 816 the lid from the top of the outside portion of the mid-section 104; removing 818 the mid-section 104; removing 820 the filter bag 700 from the cavity of the brewing section 102; overturning (i.e., flipping) 822 the mid-section 104 such that the outside portion rests on the top of the brewing section 102; placing 824 the filter bag 700 on the dilution section 200 of the mid-section 104; draining 826 the brewed effluent from the filter bag 700 into the cavity of the brewing section 102 through the dilution section 200; removing 828 filter bag 700; adding 829 ice and/or condiments (such as, for example, dairy, dairy alternatives, sweeteners, or flavorings); placing 830 the mid-section 104 back on top of the brewing section 102; filling 832 the PCBD 100 with water until the water level reaches the dilution line 300; and placing 834 the lid 106 on the mid-section 104. The method then ends.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as example implementations of such techniques.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

In some alternative examples of implementations, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A portable cold brewer with drinkware for brewing a brewed effluent from a filter bag containing an organic material, the portable cold brewer with drinkware comprising:
a brewing section having a housing,
wherein the housing includes
a brewing section top, and
a brewing cavity within the housing,
wherein the brewing cavity includes a brew line marking,
a mid-section having a dilution section and a dilution line marking, wherein the mid-section is configured to cover the brewing section top; and
a lid configured to cover the dilution section,
wherein the mid-section has
an outside portion, and
an inside portion defining a dilution cavity within the dilution section, wherein the dilution section is configured to receive the filter bag once the filter bag is removed from the brewing cavity and the mid-section is overturned and placed on the brewing section top, and
wherein
the mid-section is configured to drain the brewed effluent from the filter bag when the filter bag is in a resting position within the dilution cavity and
the dilution line marking is configured to measure an additional amount of water to fill the mid-section when the brewed effluent has drained from the filter bag.

2. The portable cold brewer with drinkware of claim 1, wherein
the brewing cavity further includes an organic material measure marking,
the organic material measure marking is configured to measure an amount of organic material that will fill the filter bag,
the brewing cavity is configured to receive the filter bag containing the organic material that was measured by the organic material measure marking, and
the brew line marking is configured to measure an amount of water to fill the brewing cavity when the filter bag is inserted into the brewing cavity.

3. The portable cold brewer with drinkware of claim 2, wherein
the organic material measure marking is at a first position approximately 36 millimeters from a brewing section bottom, and
the brew line marking is at a second position approximately 43 millimeters from the brewing section bottom.

4. The portable cold brewer with drinkware of claim 1, wherein the housing of the brewing section includes a cylindrical housing.

5. The portable cold brewer with drinkware of claim 4, wherein the outside portion of the mid-section is a cylindrical housing.

6. The portable cold brewer with drinkware of claim 4, wherein the dilution section of the mid-section includes a concave surface that acts as a funnel.

7. The portable cold brewer with drinkware of claim 1, wherein
the brewing section top of the housing includes a first set of threads,
the mid-section includes a mid-section bottom,
the mid-section bottom includes a second set of threads within the inside portion of the mid-section configured to physically interface with the first set of threads of the brewing section top, and
the inside portion of the mid-section is configured to be removably attached to the brewing section top by attaching the second set of threads to the first set of threads to form a watertight seal between the brewing section and the mid-section.

8. The portable cold brewer with drinkware of claim 7, wherein
the mid-section includes a mid-section top above the dilution cavity,
the mid-section includes a third set of threads within the inside portion of the mid-section at the mid-section top,
the lid includes a fourth set of threads that are configured to physically interface with the third set of threads of the mid-section, and
the lid is configured to be removably attached to the mid-section top by attaching the fourth set of threads to the third set of threads to form a watertight seal between the mid-section top and the lid.

9. The portable cold brewer with drinkware of claim 1, wherein the lid includes a lid handle.

10. The portable cold brewer with drinkware of claim 1, wherein the brewing section and mid-section are constructed of a material selected from the group consisting of metal, ceramic, plastic, glass, and rubber.

11. The portable cold brewer with drinkware of claim 1, wherein the brewing section has a height of approximately 178 millimeters and the mid-section has a height of approximately 76 millimeters.

12. The portable cold brewer with drinkware of claim 11, wherein the brewing section top has a diameter of approximately 85 millimeters.

13. The portable cold brewer with drinkware of claim 1, wherein the organic material is coffee or tea.

14. A method for cold brewing a brewed effluent from a filter bag containing an organic material in the portable cold brewer with drinkware having a brewing section, mid-section, and a lid, the method includes:
filling a brewing section cavity within the brewing section with the organic material until the organic material reaches an organic material measuring marking;
filling the filter bag with the organic material from the brewing section cavity;
placing the filter bag within the brewing section cavity;
adding water to the brewing section cavity until a water level of the water reaches a brew line marking within the brewing cavity;
placing the mid-section on the top of the brewing section, wherein the mid-section includes a dilution section, an outside portion, and an inside portion defining a dilution cavity within the dilution section;
placing the lid on the top of the outside portion of the mid-section;
cold brewing the brewed effluent from the filter bag containing the organic material within the brewing section;
removing the lid from the top of the outside portion of the mid-section;
removing the mid-section;
removing the filter bag from the brewing section cavity;
overturning the mid-section such that the outside portion rests on the top of the brewing cavity;
placing the filter bag within the dilution cavity of the mid-section; and
draining the brewed effluent from the filter bag into the brewing section cavity of the brewing section through the dilution section.

15. The method of claim 14, further including adding additional water to a dilution line marking within the dilution section.

16. The method of claim 15, wherein placing the mid-section on the top of the brewing section includes removably attaching the mid-section to a brewing section top of the brewing section, wherein
the brewing section top of the housing includes a first set of threads,
the mid-section includes a mid-section bottom,
the mid-section bottom includes a second set of threads within the inside portion of the mid-section below configured to physically interface with the first set of threads of the brewing section top, and
the inside portion of the mid-section is configured to be removably attached to the brewing section top by attaching the second set of threads to the first set of threads to form a watertight seal between the brewing section and the mid-section.

17. The method of claim 16, wherein placing the lid on the top of the outside portion of the mid-section includes removably attaching the lid to a mid-section top of the mid-section, wherein
the mid-section includes the mid-section top above the dilution cavity,
the mid-section includes a third set of threads within the inside portion of the mid-section at the mid-section top,
the lid includes a fourth set of threads that are configured to physically interface with the third set of threads of the mid-section, and
the lid is configured to be removably attached to the mid-section top by attaching the fourth set of threads to the third set of threads to form a watertight seal between the mid-section top and the lid.

18. The method of claim 14, wherein cold brewing the brewed effluent includes cold brewing the brewed effluent for a predetermined amount of time.

19. The method of claim 18, wherein the predetermined amount of time is between one hour to 26 hours.

20. The method of claim 18, wherein the organic material is coffee or tea.
